(19) United States
(12) Patent Application Publication
(10) Pub. No.: US 2018/0110216 A1
(43) Pub. Date: Apr. 26, 2018

(54) Combination Conditioning And Protective Apparatus

(71) Applicant: Randy Parcher, Sheridan, MI (US)

(72) Inventor: Randy Parcher, Sheridan, MI (US)

(21) Appl. No.: 15/686,550

(22) Filed: Aug. 25, 2017

Related U.S. Application Data
(60) Provisional application No. 62/411,883, filed on Oct. 24, 2016.

(51) Int. Cl. A01M 31/06; A01M 31/02

(52) U.S. Cl. CPC A01M 31/06; A01M 31/02

(57) ABSTRACT

An apparatus for conditioning wild game animal to human presence. The apparatus comprises a planar element fabricated from a lightweight material that is shaped to resemble a human head and a human torso. The planar element includes a representation of a human form on a first side.

### CROSS-REFERENCE TO RELATED APPLICATION

This application claims the benefit of U.S. Provisional Application Ser. No. 62/411,883, filed on Oct. 24, 2016, the entire disclosure of which is incorporated herein by reference.

### TECHNICAL FIELD

This disclosure relates to generally to the field of hunting, and more particularly, to an apparatus for conditioning game to the presence of a human form in a hunting shelter and providing protection to the hunter from the elements.

### BACKGROUND

Hunters frequently utilize blinds and elevated platforms, sometimes referred to as “deer stands,” affixed to or located near trees in a hunting area. These devices provide shelter for the hunter, who frequently spends relatively long hours on the hunt, waiting for targets of opportunity to come into range and view. Wild game animals, however, have keen auditory, visual and olfactory senses, and are adept at discerning the presence of humans nearby. It is believed that wild game animals are capable of sensing visual differences in the environment, for example, wild game animals can determine that a hunting shelter is or is not occupied. Over time, wild game animals become accustomed to the visual cues associated with a hunting shelter, so that if the hunting shelter is, for a long period of time, unoccupied, the wild game animals will quickly sense a change in that environment, i.e., when the hunting shelter becomes occupied.

### SUMMARY

Apparatuses for conditioning wild game animals to human presence are disclosed. According to a first implementation, the apparatus comprises a planar element fabricated form a lightweight material that is shaped to resemble a human head and a human torso. The planar element includes a representation of a human form on a first side.

The lightweight material can be corrugated plastic. A second representation of the human form can be provided on a second side of the planar element. A first camouflage pattern can be displayed on the first side of the planar element, and a second camouflage pattern can be displayed on the second side of the planar element. The representation of the human form provided on the first side can be different than the second representation of the human form provided on the second side. The representation of the human form provided on the first side can be substantially similar as the second representation of the human form provided on the second side. The apparatus can include a hinge configured to allow the planar element to be folded. The apparatus can include an aperture extending through the planar element that is capable of receiving a fastener. The apparatus can include two elongated straps configured to secure the planar element to an external object.

According to a second implementation, the apparatus comprises a hunting stand having an opening and a planar element fabricated from a lightweight material. The planar element is shaped to resemble a human head and a human torso and includes a representation of a human form on a first side. The planar element is disposed within the hunting stand with the representation of the human form visible through the opening of the hunting stand and serves as a wind block to protect the hunter.

The hunting stand can have two openings that are directly opposite one another. The planar element can include a second representation of the human form on a second side. The representation of the human form on the first side can be visible through one of the two openings of the hunting stand. The second representation of the human form on the second side can be visible through the other of the two openings of the hunting stand. A second representation of the human form can be provided on a second side of the planar element that is different than the representation of the human form provided on the first side of the planar element. A second representation of the human form can be provided on a second side of the planar element that is substantially similar as the representation of the human form provided on the first side of the planar element. The apparatus can include a fastening mechanism that secures the planar element to an object within the hunting stand. The apparatus can include a hinge configured to allow the planar element to be folded.

According to a third implementation, the apparatus includes a ladder tree stand with a platform and a planar element fabricated from a lightweight material. The planar element is shaped to resemble a human head and a human torso and includes a representation of a human form on a first side. The planar element is secured above the platform of the ladder tree stand and minimizes contact between the hunter and the tree when the ladder tree stand is adjacent to a tree.

A second representation of the human form can be provided on a second side of the planar element that is different than the representation of the human form provided on the first side of the planar element. A second representation of the human form can be provided on a second side of the planar element that is substantially similar as the representation of the human form provided on the first side of the planar element. The apparatus can include a fastening mechanism that secures the planar element to the tree that the ladder tree stand is adjacent to. The apparatus can include a hinge that is configured to allow the planar element to be folded.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows a front side of an apparatus for conditioning game to human presence according to a first implementation.

FIG. 2 shows a back side of the apparatus according to a second implementation.

FIG. 3 shows the apparatus according to a third implementation.

FIG. 4 shows the apparatus positioned in a window of a hunting shelter.

FIG. 5 shows the apparatus positioned on a ladder tree stand next to a tree.

### DETAILED DESCRIPTION

A mannequin's head and torso or an inflatable decoy resembling a human can be used to simulate an occupant of a hunting shelter or ladder tree stand. Over time, wild game animals near the hunting shelter or the ladder tree stand will see the simulated occupant and believe that the occupant presents no threat. As a result, wild game animals will become accustomed to the simulated occupant and approach the hunting shelter without concern. Mannequins are three-dimensional, and as a result, can be bulky and heavy to transport to the hunting shelter or the ladder tree stand, which can involve carrying the mannequins over long distances on foot. Inflatable decoys are more easily transported. However, inflatable decoys are prone to puncture and can collapse over time.

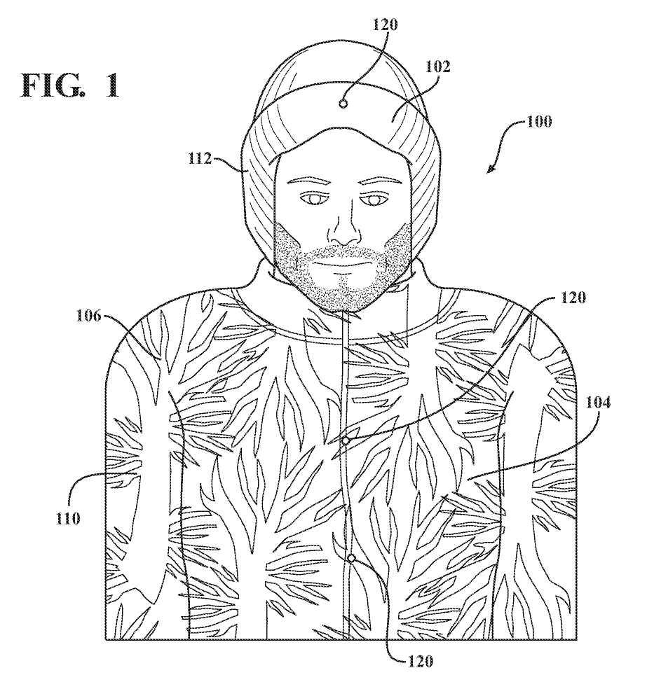

FIGS. 1-4 illustrate an apparatus 100 for conditioning game to human presence that is lightweight, highly portable, and durable. The apparatus 100 can be a substantially planar, two-dimensional representation of a head 102 and a torso 104 of a hunter. The apparatus 100 can be fabricated from a lightweight material, such as corrugated plastic. In the illustrated, non-limiting example, the apparatus 100 is made from corrugated plastic that is approximately 3/16 of an inch thick. The use of the corrugated plastic allows the apparatus 100 to be extremely lightweight and rugged.

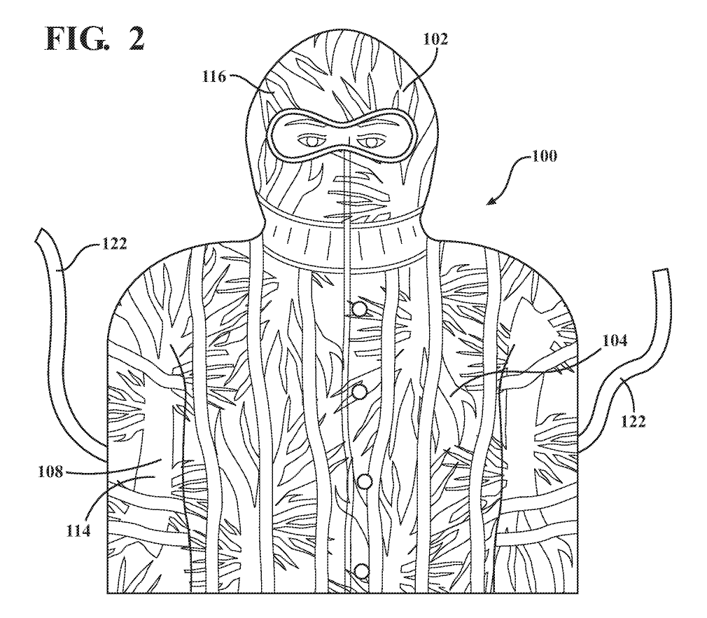

A front side 106 and/or a back side 108 of the apparatus 100 can be decorated to simulate a typical appearance of the hunter, such as facial features, a hat, and camouflage clothing. Any known method of coloring or decoration can be used, such as using a paint, dye, or applique. A finish of the apparatus 100 can be dull so that the apparatus 100 does not reflect or shine. The apparatus 100 can also feature an image of an image of a weapon (not shown), such as a rifle or a bow and arrow, positioned across the torso 104 of the hunter. The decorations on the front side 106 and the back side 108 of the apparatus 100 can be different, such as having different camouflage patterns. This allows the user to easily change the appearance of the apparatus 100 by simply reversing the apparatus 100. As shown in the illustrated, non-limiting example, the front side 106 of the apparatus 100 is shown in FIG. 1 with a first camouflage pattern 110 and a hat 112, and the back side 108 of the apparatus is shown in FIG. 2 with a second camouflage pattern 114 and a face mask 116.

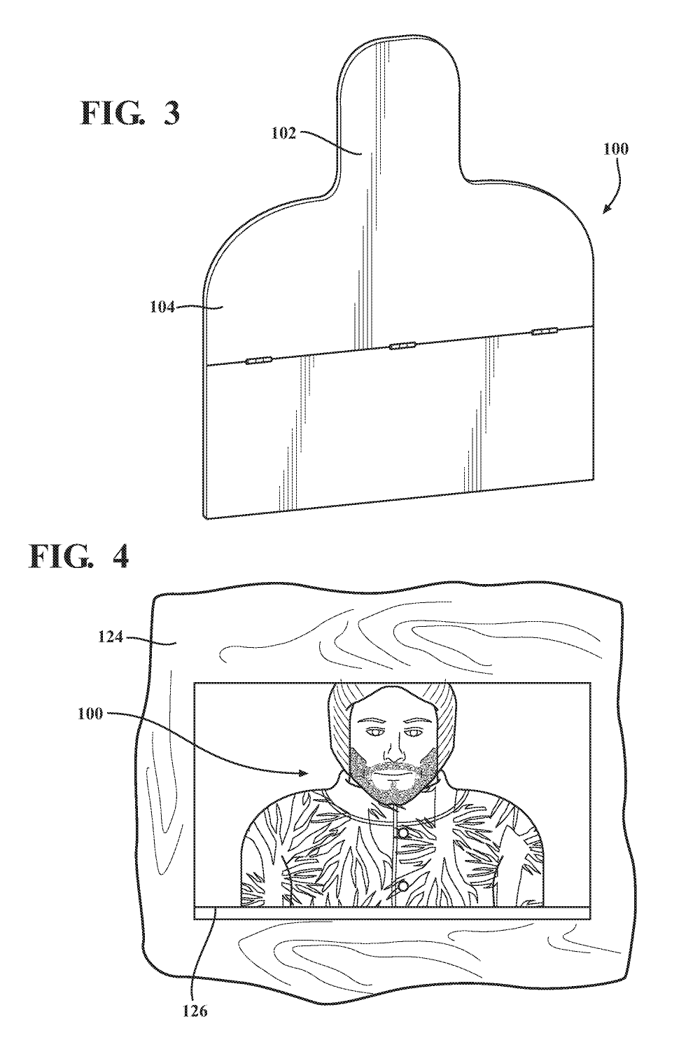

The apparatus 100 is sized so that the apparatus 100 is large enough to provide protection to the user from the elements. To assist with transportation of the apparatus 100, the apparatus 100 can be provided hinges 118, as shown in FIG. 3. The hinges 118 allow the apparatus 100 to be folded or collapsed. The hinges 118 can be rigid or flexible and be made from any suitable material, such as vinyl, plastic, or metal.

To assist with securing the apparatus 100 to an object, the apparatus 100 can be provided with a fastening mechanism. The fastening mechanism can allow the apparatus 100 to be reusable and relocated at the user's election without the need for complicated tools. In FIG. 1, the apparatus 100 is provided with apertures 120 that are sized to receive a fastener (not shown), such as a screw. In FIG. 2, the apparatus 100 is provided with two elongated straps 122, such as ties or hook and loop fasteners.

FIG. 4 shows the apparatus 100 in use within a hunting shelter 124. The hunting shelter 124 can be on the ground or elevated. The apparatus 100 is positioned so that one of the decorated sides, such as the front side 106 or the back side 108, is visible through an opening 126, such as a window, to passing wild game animals. If the hunting shelter 124 has two openings 126 that are directly opposite one another, it can be advantageous to decorate both the front side 106 and the back side 108 so that the wild game animals see a simulated occupant through either opening 126. By blocking some or all of the opening 126, the apparatus 100 can protect the user from weather elements, such as wind or rain.

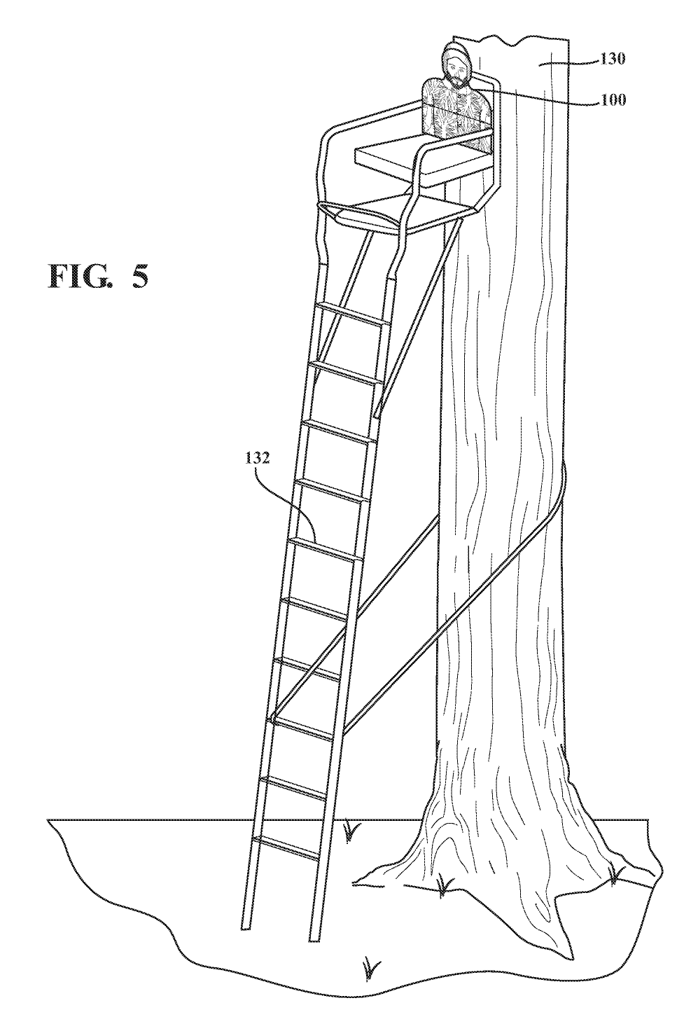

FIG. 5 shows the apparatus 100 in use with a ladder tree stand 128. The ladder tree stand 128 is vertically secured adjacent to a tree 130. The apparatus 100 can then be secured to the tree 130 above a platform 132 of the ladder tree stand 128. By positioning the apparatus 100 between the user and the tree 130, the apparatus 100 can serve as a wind blocker while the user is on the platform 132 and minimize contact between the user and containments of the tree 130, such as sap extrusion.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus for conditioning wild game animals to human presence, the apparatus comprising:
a planar element fabricated from a lightweight material that is shaped to resemble a human head and a human torso and includes a representation of a human form on a first side.

2. The apparatus of claim 1, wherein the lightweight material is corrugated plastic.

3. The apparatus of claim 1, wherein a second representation of the human form is provided on a second side of the planar element.

4. The apparatus of claim 3, wherein a first camouflage pattern is displayed on the first side of the planar element and a second camouflage pattern is displayed on the second side of the planar element.

5. The apparatus of claim 3, wherein the representation of the human form provided on the first side is different than the second representation of the human form provided on the second side.

6. The apparatus of claim 3, wherein the representation of the human form provided on the first side that is substantially similar as the second representation of the human form provided on the second side.

7. The apparatus of claim 1, further comprising:
a hinge configured to allow the planar element to be folded.

8. The apparatus of claim 1, further comprising:
an aperture extending through the planar element capable of receiving a fastener.

9. The apparatus of claim 1, further comprising:
two elongated straps configured to secure the planar element to an external object.

10. An apparatus for conditioning wild game animals to human presence and protecting a hunter, the apparatus comprising:
a hunting stand having an opening; and
a planar element fabricated from a lightweight material that is shaped to resemble a human head and a human torso and includes a representation of a human form on a first side, wherein the planar element is disposed within the hunting stand with the representation of the human form visible through the opening of the hunting stand, and wherein the planar element serves as a wind blocker to protect the hunter.

11. The apparatus of claim 10, wherein the hunting stand has two openings directly opposite one another, the planar element includes a second representation of the human form on a second side, the representation of the human form on the first side is visible through one of the two openings of the hunting stand, and the second representation of the human form on the second side is visible through the other of the two openings of the hunting stand.

12. The apparatus of claim 10, wherein a second representation of the human form is provided on a second side of the planar element that is different than the representation of the human form provided on the first side of the planar element.

13. The apparatus of claim 10, wherein a second representation of the human form is provided on a second side of the planar element is substantially similar as the representation of the human form provided on the first side of the planar element.

14. The apparatus of claim 10, further comprising:
a fastening mechanism that secures the planar element to an object within the hunting stand.

15. The apparatus of claim 10, further comprising:
a hinge configured to allow the planar element to be folded.

16. An apparatus for conditioning wild game animals to human presence and protecting a hunter, the apparatus comprising:
a ladder tree stand with a platform; and
a planar element fabricated from a lightweight material that is shaped to resemble a human head and a human torso and includes a representation of a human form on a first side, wherein the planar element is secured above the platform of the ladder tree stand minimizes contact between the hunter and a tree when the ladder tree stand is adjacent to the tree.

17. The apparatus of claim 16, wherein a second representation of the human form is provided on a second side of the planar element that is different than the representation of the human form provided on the first side of the planar element.

18. The apparatus of claim 16, wherein a second representation of the human form is provided on a second side of the planar element is substantially similar as the representation of the human form provided on the first side of the planar element.

19. The apparatus of claim 16, further comprising:
a fastening mechanism that secures the planar element to the tree that the ladder tree stand is adjacent to.

20. The apparatus of claim 16, further comprising:
a hinge configured to allow the planar element to be folded.
